(19) United States
(12) Patent Application Publication
(10) Pub. No.: US 2023/0325702 A1
(43) Pub. Date: Oct. 12, 2023

(54) ULTRA LONG STORAGE ASSISTED QUANTUM MEMORY

(71) Applicant: QULABZ INC., Kendall Park, NJ (US)

(72) Inventors: Devendra MISHRA, Varanasi (IN); Rikteem BHOWMICK, Tinsukia (IN); Nixon PATEL, Kendall Park, NJ (US)

(21) Appl. No.: 18/308,555

(22) Filed: Apr. 27, 2023

(30) Foreign Application Priority Data
Mar. 22, 2022 (IN) 202211015924

(51) Int. Cl. G06N 10/40

(52) U.S. Cl. CPC G06N 10/40

(57) ABSTRACT

Techniques for quantum data storage are described. A method for quantum data storage in ultra long storage assisted quantum memory includes obtaining quantum data from an input quantum channel to be stored in a memory unit, storing, intermediately, the quantum data in a first medium of the memory unit for a first pre-determined amount of time, reabsorbing quantum data emitted from the first medium after the first pre-determined amount of time by at least one multiple dot heterostructure of the memory unit, where the at least one multiple dot heterostructure comprises a potential well for storing the quantum data, storing quantum data in the at least one multiple dot heterostructure for a second predetermined amount of time, and performing a controlled tunneling of the quantum data stored in the at least one multiple dot heterostructure.

### BACKGROUND

### Technical Field

The present subject matter relates, in general, to quantum memories, and in particular, to ultra long storage of quantum data and quantum data retrieval in a device for quantum data storage.

### Description of the Related Art

Quantum memory facilitates storage of quantum data. For example, in technologies, such as quantum computing, quantum communications, quantum information processing, and the like, quantum memory is used to store a quantum state of the quantum data. Quantum states of quantum data possess computational information known as qubits, where qubits are basic units of information in quantum computing. Unlike classical bits, which are binary and can hold only a position of either 0 or 1, qubits exist in a state of superposition. Quantum particles that exist in a state of superposition are a combination of all the possible quantum states, in which the quantum particles may exist.

Different quantum memories may utilize different techniques for storage of quantum data, such as electromagnetically induced transparency (EIT), atomic frequency comb protocol, control reversible inhomogeneous broadening or gradient echo and Raman quantum techniques. In EIT based memories, two optical fields which are highly coherent light sources, such as lasers, are generally tuned to interact with three quantum states of a material used in the EIT based memories. Tuning of the two optical fields near these quantum states results in creating a spectral window of transparency, which facilitate storing, and retrieving of the quantum data from the three quantum states.

### BRIEF DESCRIPTION OF THE SEVERAL VIEWS OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a method for storing and retrieval of quantum data, in accordance with an example implementation of the present subject matter.

FIGS. 2(a)-2(e) illustrate a controlled tunneling process, in accordance with an example implementation of the present subject matter.

FIG. 3 illustrates a method for localized error correction, in accordance with an example implementation of the present subject matter.

FIG. 4 illustrates a quantum computing communication environment implementing an ultra long storage assisted quantum memory, in accordance with an example implementation of the present subject matter.

FIG. 5(a) illustrates a schematic representation of a quantum memory, in accordance with an example implementation of the present subject matter.

FIG. 5(b) illustrates a top view of the multiple dot heterostructure in a quantum memory, in accordance with an example implementation of the present subject matter.

FIG. 5(c) illustrates a partial lateral view of quantum memory, in accordance with an example implementation of the present subject matter.

FIG. 5(d) illustrates another schematic representation of a quantum memory, in accordance with another example implementation of the present subject matter.

FIG. 6 illustrates another schematic representation of the quantum memory, in accordance with an example implementation of the present subject matter.

FIG. 7 illustrates a schematic representation with multiple units of quantum memory, in accordance with an example implementation of the present subject matter.

### DETAILED DESCRIPTION

The present subject matter relates to quantum memories, specifically to storage and retrieval of quantum data to achieve prolonged periods of storage time and improve the fidelity of stored quantum data.

In known techniques of quantum data storage based on electromagnetically induced transparency (EIT), when quantum data is stored in a quantum memory, photon absorption in a three-level lambda system is performed. In operation, the three-level lambda system includes a ground state, an excited state, and a storage state. A probe or a signal field, which is a weak field laser, containing quantum data is introduced. This signal field is considered as a quantized electric field in which the photons are in a state of coherence. The signal field is stored in the quantum memory and retrieved with the help of a pump, or alternatively referred to as, a control field. The control field is a strong field laser used for controlling the storage process of the quantum data. When the probe field is absorbed by an electron in the ground state, the electron carrying the quantum data transits from the ground state to the excited state of the three-level lambda system, the control field is used to shift the excitation from the excited state to the storage state. The quantum data is stored in the superposition of ground and storage state for a short period of time.

On the demand of retrieval, the control field is used again to shift the excitation of the electron back from the storage state to the excited state. The control field causes the emission of photon stored in the storage state to the excited state, and from the excited state to the ground state, thereby facilitating retrieval of quantum data from the quantum memory.

When the excitation of the electron carrying quantum data, shifts from the excited state to the storage state, which is a hyperfine level state of the ground state itself, further transition from the storage state to ground state is electrically forbidden. However, magnetic dipole transitions are allowed, hence, due to the spontaneous emission of the quantum data stored in the storage state, the quantum data decoheres within the storage time. Thus, after a particular time period, such as coherence time, the quantum data begins to decohere. This phenomenon is referred to as a spin fluctuation or spin decoherence of the stored quantum data. Therefore, the storage time of quantum data is dependent on the coherence time of the quantum data stored, which allows the storage of quantum data only until the quantum data is in a state of coherence.

In some known techniques, to overcome the phenomena of spin decoherence, a process of dynamical decoupling is used. In dynamical decoupling, when quantum data is stored in the storage state, quantum data is subjected to spin fluctuations and the quantum data tends to move towards the ground state. In such situation, to avoid the decoherence of quantum data, a radiofrequency pulse is applied to the quantum data that begins decaying to the ground state. In another example, multiple sequences of π pulses are applied to push the quantum data back and forth between the storage state and the ground state. This also causes the data to momentarily lie in a state of superposition between the storage and ground state. The process of dynamical decoupling thus allows the quantum data to be stored for a time period in the range of a few seconds to thirty minutes. While the process of dynamical decoupling allows the quantum data to be stored for a time period longer than the storage time of quantum data subjected to the EIT phenomenon alone, this process results in a decrease in the fidelity of the quantum data, which in turn results in degradation in the quality of the quantum data stored in the quantum memory. The decrease in fidelity of the quantum data and degradation of the quantum data stored also limits the distance to which quantum communication can be performed.

The present subject matter addresses these and other problems of conventional quantum data storage techniques as discussed above and provides techniques for enhanced quantum data storage and retrieval. The present subject matter provides techniques for storage and retrieval of quantum data, such that quantum data may be stored for prolonged periods of time. Additionally, the present subject matter provides techniques to improve the fidelity of the quantum data to be stored and retrieved without deterioration in the quality of the data stored.

In operation, quantum data is obtained as input from an input quantum channel for storage, multiplexed and stored in a first medium of a memory unit. The multiplexed quantum data is absorbed by the first medium, and stored intermediately, for a first pre-determined amount of time. The quantum data stored in the first medium is emitted after the first-predetermined amount of time. The quantum data emitted from the first medium, is re-absorbed by a multiple dot heterostructure of the memory unit. The quantum data absorbed by the multiple dot heterostructure is stored for a second pre-determined amount of time. To store the quantum data in the multiple dot heterostructure, an electromagnetically induced transparency technique is employed. The electromagnetically induced transparency technique allows storage of quantum data and creates a window of transparency in the multiple dot heterostructure to cease the absorption process. On ceasing the absorption process, controlled tunneling of an electron that carries quantum data stored in the multiple dot heterostructure is performed, for prolonged storage. Controlled tunneling of quantum data includes sequentially tunnelling of the electron carrying quantum data from one quantum dot of the multiple dot heterostructure into another quantum dot of the multiple dot heterostructure, to maintain the quantum data stored in a state of coherence. The controlled tunneling is performed for a predefined number of times, after which the quantum data may be emitted from the multiple dot heterostructure. On emission of the quantum data from the multiple dot heterostructure, after the second pre-determined amount of time, the quantum data is reabsorbed by the first medium of the memory unit.

The storage of quantum data multiple times, i.e., the absorption and re-absorption of the quantum data into the first medium, or the multiple double dot heterostructure of the memory unit, facilitates a substantial increase in the storage time of the quantum data. In one example, the memory unit is provided with carbon nanotubes, metallofullerenes, multiple dot heterostructures, or a combination thereof, as mediums in the memory unit to facilitate storage of quantum data.

Additionally, when quantum data is stored in the multiple dot heterostructure of the memory unit, spin manipulation and local error correction techniques are employed. The local error correction performed on the quantum data stored, is based on a location of the multiple dot heterostructure on the memory unit. The localized error correction and spin manipulations employed at every or alternate multiple dot heterostructure, provides an improved fidelity of the quantum data stored, which in turn, prevents deterioration in the quality of the quantum data stored and retrieved.

The present subject matter thus provides an efficient technique for storage and retrieval of quantum data multiple times, thereby increasing the storage time. The present subject matter also provides an improved fidelity of the quantum data stored, thereby reducing the possibility of deterioration in the quality of the data stored.

The above and other features, aspects, and advantages of the subject matter will be better explained with regards to the following description and accompanying figures. It should be noted that the description and figures merely illustrate the principles of the present subject matter along with examples described herein and should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numbers are used throughout the drawings to reference like features and components.

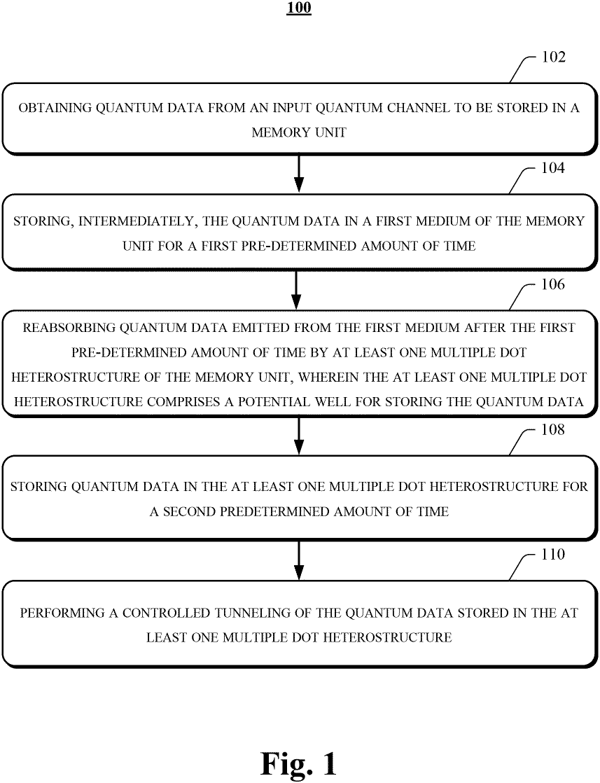

FIG. 1 illustrates a method 100 for storing of quantum data, in accordance with an example implementation of the present subject matter. At block 102, the method 100 includes obtaining quantum data from an input quantum channel to be stored in a memory unit. In one example, the input quantum channel, such as an optical fiber for single-photon quantum data may be used. In one example, quantum data may be encoded in photons emitted from a single photon source, where the quantum data is in the form of photonic qubits. In one example, a signal pulse may carry the quantum data.

In one example, the quantum data obtained may be multiplexed. Multiplexing of the quantum data is beneficial in the process of Entanglement purification. Entanglement purification improves and maintains the fidelity of stored entanglement with the help of multiple quantum data. As would be understood by a person skilled in the art, multiplexing of quantum data may be performed in multiple degrees of freedom, such as spatial multiplexing, temporal multiplexing, spectral multiplexing, polarization multiplexing, orbital angular momentum multiplexing, and the like. On multiplexing the quantum data obtained, the multiplexed quantum data, alternatively referred to as quantum data, may be stored in a memory unit.

At block 104, the method includes storing, intermediately, the quantum data in a first medium of the memory unit for a first pre-determined amount of time. In one example, the signal pulse carrying the quantum data, alternatively referred to as quantum data, may be directed towards the first medium of the memory unit, which may result in an interaction between the quantum data and the first medium. In one example, the first medium of the memory unit may absorb the quantum data and store the absorbed quantum data for a first pre-determined amount of time. In one example, the first pre-determined amount of time may be based on the first medium, where the pre-determined amount of time may be dependent on the inherent properties of the first medium. In one example, the first medium may be a metallofullerene encapsulated carbon nanotube. After the first pre-determined amount of time, the absorbed quantum data may be emitted from the first medium spontaneously.

In another example, the quantum data stored in the first medium may be retrieved from the memory unit on demand of retrieval, i.e., an amount of time for which the quantum data may be stored in the first medium may be controlled. In one example, techniques such as Atomic Frequency Comb (AFC) may be employed by methods known in the art, to control the duration for which quantum data may be stored in the first medium of the memory unit. In yet another example, the quantum data emitted from the first medium may be re-absorbed by the first medium of the memory unit for an increased storage time.

At block 106, the method includes reabsorbing quantum data emitted from the first medium after the first pre-determined amount of time by a multiple dot heterostructure of the memory unit, wherein the multiple dot heterostructure comprises a potential well for storing the quantum data.

At block 108, the method includes storing quantum data in the multiple dot heterostructure for a second predetermined amount of time. The method includes storing the quantum data in a multiple dot heterostructure of the memory unit, by subjecting the quantum data to electromagnetically induced transparency. In one example, the multiple dot heterostructure structure may be a part of the memory unit. The multiple dot heterostructure may include a plurality of quantum dots. Each quantum dot may be formed and controlled externally through a nano-gate assembly. In one example, the multiple dot heterostructure may include a pair of quantum dots, namely a first quantum dot and a second quantum dot, collectively and alternatively referred to as a double dot heterostructure. Each quantum dot of the double dot heterostructure may include a potential well formed between potential walls. The voltage of the potential wall may be maintained and controlled by a control panel associated with the nano-gate assembly corresponding to each quantum dot. In one example, the control panel may be configured to maintain the voltage of the potential walls at a desired range. The equation (1) as depicted below represents an example of voltage control of the voltage at the potential wall:

$$C = \left[v \left(W 1\right) + v \left(W 2\right) + v \left(W 3\right)\right] \qquad \text{(1)}$$

Where, C represents the voltage control signal, v(W1) represents a voltage of a first outer potential wall of the first potential well formed in the first quantum dot of the double dot heterostructure, v(W2) represents a voltage of an interior potential wall, formed in between the first potential well and the second potential well of the first quantum dot and the second quantum dot, respectively, and v(W3) represents a voltage of a second outer potential wall of the second potential well formed in the second quantum dot of the double dot heterostructure.

In one example, the quantum data emitted from the first medium of the memory unit may enter the first quantum dot of the multiple dot heterostructure. The quantum data that enters the first quantum dot may interact with a single electron, alternatively referred to as a transiting electron, present in the first potential well of the first quantum dot. In one example, the first quantum dot of the multiple dot heterostructure may borrow the single electron from a material surrounding the multiple dot heterostructure. The interaction between the electron and the quantum data may result in an absorption of the quantum data. The quantum data absorbed in the first quantum dot of the multiple dot heterostructure, may exist in multiple states of energy.

The multiple states of energy may be arranged in a vee type configuration, a delta type configuration, or a lambda type configuration. Although the following description has been explained with respect to the lambda configuration formed by three states of energy, similar principles may be applicable to higher number states of energy and different configuration arrangements of the energy states. In one example, three states of energy may be formed in the first quantum dot, namely, a ground state, an excited state, and a storage state, arranged in a lambda configuration. The three states of the potential well may be arranged, such that the ground state is at the lowest level of the potential well, the excited state is at the highest level of the potential well and the storage state is in between the ground state and the excited state.

As would be understood by a person skilled in the art, electromagnetically induced transparency (EIT) is a coherent optical nonlinearity which renders a medium transparent within a narrow spectral range around an absorption line. To achieve electromagnetically induced transparency, the signal pulse carrying the quantum data and a control pulse may be directed towards the single electron in the first potential well of the first quantum dot. In one example, the signal pulse carrying the quantum data and the control pulse may be highly coherent light sources, such as lasers, which may be tuned to interact with three quantum states of the system. The signal pulse carrying the quantum data and the control pulse are provided to allow a transition of the quantum data from one state to another via the single electron, also referred to as a transiting electron. Each transition of data from one energy state to another energy state may take place at a particular wavelength. In one example, a wavelength of the signal pulse and the control pulse may lie in the range of 1260 nm to 1675 nm. This wavelength region facilitates propagation of quantum data in the memory unit with minimum characteristic losses.

Initially, when the quantum data is absorbed by the multiple dot heterostructure, the transiting electron may lie in the ground state. In one example, the signal pulse carrying the quantum data directed towards the transiting electron, may cause the quantum data to transit from the ground state to the excited state through the transiting electron. In one example, the control pulse and the signal pulse carrying the quantum data may be continued to be provided until an optimum frequency ωₒ is attained, in order to achieve the EIT phenomenon at a resonant frequency. In one example, the transiting electron may transit from the ground state to the excited state at resonant frequency, which is when the frequency of the signal pulse equals the frequency at which the transiting electron carrying quantum data transits from the ground state to the excited state. Similarly, the control pulse directed towards the transiting electron may cause the electron to transit from the excited state to the storage state at resonant frequency, which is when the frequency of the control pulse equals the frequency at which the transiting electron carrying quantum data transits from the excited state to the storage state.

On achieving electromagnetically induced transparency, the absorption process ceases. Once the absorption process ceases, the control pulse and the signal pulse carrying quantum data may be turned off for the second pre-determined amount of time. When the control pulse and the signal pulse carrying quantum data are turned off, the quantum data absorbed by the transiting electron may be stored at the storage state. In one example, the transiting electron carrying the quantum data may rest in a state of coherence at the storage state for a first preset amount of time ‘t,’ after which the quantum data may start to decohere or decay spontaneously. The first preset amount of time is a time period between the state of coherence and a decoherence state of the quantum data in the first potential well. In one example, the first preset amount of time ‘t’ may be referred to as the relaxation time. In one example, the relaxation time may lie in a range of a few milliseconds to a few seconds.

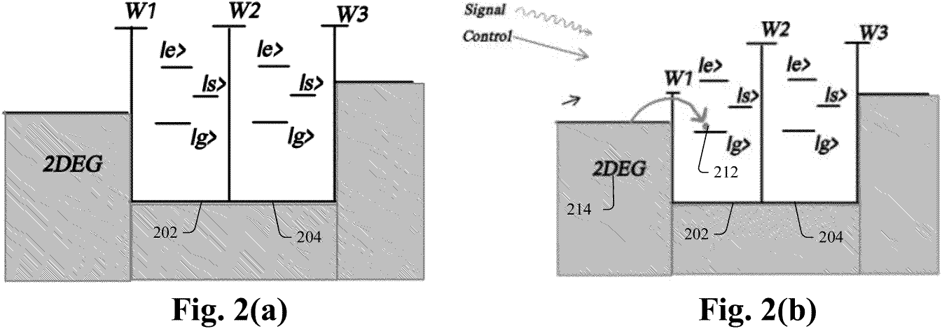

At block 110, the method 100 includes performing controlled tunneling of the quantum data stored in the multiple dot heterostructure. In one example, controlled tunneling is performed on the transiting electron carrying the quantum data, subjected to electromagnetically induced transparency, for prolonged storage. In one example, before the relaxation time lapses, i.e., before the quantum data stored in the first potential well of the first quantum dot starts to decohere, the transiting electron carrying the quantum data may be tunneled into the second potential well of the second quantum dot of the multiple dot heterostructure. The quantum data may then be stored in the second potential well for a second preset time. The second preset amount of time is the time period between the state of coherence and the decoherence state of the quantum data in the second potential well. In one example, the second preset time may correspond to a time period from when the quantum data is introduced to the second potential well to an instant before which the quantum data starts to decohere. In one example, just before the quantum data stored in the second potential well starts to decay or decohere, the transiting electron carrying the quantum data may be tunneled back into the first potential well. The process of tunnelling the transiting electron carrying the quantum data from the first potential well of the first quantum dot to the second potential well of the second quantum dot, and back to the first potential well of the first quantum dot, to maintain the quantum data in a state of coherence may be referred to as a ping-pong phenomenon. In one example, the controlled tunnelling of the quantum data stored, from one potential well to another potential well may be repeated for a predefined number of times. The process of controlled tunneling is further explained with reference to FIGS. 2(a)-2(e). Therefore, based on the number of times controlled tunnelling of transiting electron carrying the quantum data is performed, while maintaining the data in a state of coherence, the storage time of quantum data may be significantly increased.

In one example, in order to retrieve the stored quantum data, the control pulse may be directed towards the multiple dot heterostructure of the memory unit. Directing the control pulse for retrieval of the quantum data may result in the transition of the transiting electron carrying the quantum data from the storage state to the excited state, after which the transiting electron may spontaneously move towards the ground state. Once the transiting electron transits to the ground state, quantum data stored in the transiting electron may be emitted from the multiple dot heterostructure in the form of a retrieved signal pulse. Thus, when the control pulse is turned on and directed towards the quantum data stored in multiple dot heterostructure, the quantum data may be emitted from the multiple dot heterostructure.

In one example, the quantum data emitted from the multiple dot heterostructure may be re-absorbed into the first medium. In a scenario, where the quantum data emitted from the multiple dot heterostructure is re-absorbed by the first medium, the quantum data may be re-stored for the first pre-determined amount of time. Therefore, the technique of absorption and re-absorption at multiple stages, results in an increased storage time of quantum data.

FIGS. 2(a)-2(e) illustrate a controlled tunneling process, in accordance with an example implementation of the present subject matter. The following description has been explained with respect to the multiple dot heterostructure being a double dot heterostructure, for the sake of simplicity. However, similar principles may be applicable to any multiple dot heterostructure, with multiple quantum dots. As shown in the figure, a first potential well 202 may be formed in the first quantum dot (not shown in the figure) and a second potential well 204 may be formed in the second quantum dot (not shown in the figure) of the double dot heterostructure (not shown in the figure). In one example, the first quantum dot and the second quantum dot may be formed and controlled by a nano-gate assembly embedded in a material surrounded by the double dot heterostructure.

In one example, the first potential well 202 and the second potential well 204 may be formed in the double dot heterostructure, such that the first potential well 202 and the second potential well 204 share an interior potential wall (W2). Further, the first potential well 202 includes a first outer potential wall (W1) and the second potential well 204 includes a second outer potential wall (W3). The potential of the first outer potential wall (W1), the interior potential wall (W2), and the second outer potential wall (W3), collectively referred to as potential walls, may be nano-gate controlled. In one example, the potential walls of the first potential well 202 and the second potential well 204 may be maintained at an equal level or may be varied with respect to one another.

In one example, the quantum data that is absorbed in the double dot heterostructure may exist in three states, as depicted in FIG. 2(a). The three states may be formed in the first potential well 202 and the second potential well 204. In one example, the first state of the three states may be a ground state |g >, the second state may be an excited state |e >, and the third state may be a storage state |s >. In one example, as explained above, for the controlled tunnelling, alternatively referred to as the ping-pong phenomenon, a single electron 212 as depicted in FIG. 2(b) may be tunneled into the first potential well 202 from the material 214 surrounding the double dot heterostructure. In one example, the material that surrounds the double dot heterostructure may be a 2D Electron Gas (2DEG). The single electron 212 that is tunneled into the first potential well 202 may initially rest in the ground state |g >.

Further, when the quantum data enters the first potential well 202 of the first quantum dot, the quantum data may be absorbed by the electron in the ground state |g > of the first potential well 202, by being subjected to the EIT technique as described above. Through the EIT technique, the quantum data may transit from the ground state |g > to the storage state |s >, through the excited state |e > as depicted in FIG. 2(c). The quantum data may be stored in the storage state |s > of the first potential well 202, until the quantum data is in a state of coherence. In one example, controlled tunneling of the quantum data between the first potential well 202 and the second potential well 204 may be performed based on the spin energy of the quantum data stored. Controlling a potential of the first potential well and the second potential well of the multiple dot heterostructure facilitates controlled tunneling of the stored quantum data.

In one example, the potential at the first outer potential wall (W1) and the second outer potential wall (W3) may be kept constant, and the potential of the interior potential wall (W2) alone may be controlled and varied. In one example, potential at the first outer potential wall (W1) and the second outer potential wall (W3) may be kept constant, such that the transiting electron carrying the quantum data does not tunnel out of the double dot heterostructure. Initially, the potential at the interior potential wall (W2) may be maintained at V₁ as depicted in FIG. 2(d). The potential at the interior potential wall (W2) may be maintained at V₁, such that the probability of the transiting electron 212 tunnelling from the first potential well 202 to the second potential well 204 is negligible. Thus, ensuring that the transiting electron 212 may be confined to the first potential well 202. On absorption of the quantum data in the first potential well 202, in one example, just before the relaxation time of the stored quantum data in the first potential well 202 lapses, the potential at the interior potential wall (W2) may be reduced to V₂. Reduction in the potential at the interior potential wall (W2) may cause the quantum data to exist in a state of superposition between the first potential well 202 and the second potential well 204, thereby facilitating tunneling of the quantum data from the first potential well 202 to the second potential well 204. Once the quantum data is tunneled into the second potential well 204, the potential at the interior potential wall (W2) may be increased to V₁, such that quantum data may be stored in the second potential well 204, until the quantum data remains is in a state of coherence. Similar to the quantum data stored in the first potential well 202, just before the onset of decoherence of the quantum data stored in the second potential well 204, the quantum data may be tunneled back into the first potential well 202. To tunnel the quantum data back into the first potential well 202, the potential at the interior potential wall (W2) may be reduced to V₂. Reduction in the potential at the interior potential wall (W2) may cause the quantum data to exist in a state of superposition between the first potential well 202 and the second potential well 204, thereby facilitating tunneling of the quantum data from the second potential well 204 to the first potential well 202.

As depicted in the FIG. 2(d), tunneling of the quantum data from the first potential well 202 to the second potential well 204, and vice-versa may be represented by the path T. In one example, the nano-gate assembly may be configured to perform the controlled tunneling process, where tunneling of quantum data from the first potential well 202 to the second potential well 204, and back to the first potential well 202, may be performed for a predefined number of times to maintain the data in a state of coherence. The controlled tunneling of quantum data, thus results in increasing the storage time of quantum data in the memory unit.

In another example, when the quantum data stored in the first potential well 202 or the second potential well 204 does not possess sufficient spin energy to tunnel into the second potential well 204 or the first potential well 202 respectively, external signals may be directed towards the quantum data stored in the potential well 202, 204 to facilitate the controlled tunnelling or the ping-pong phenomenon. In one example, the external signal may be a microwave pulse.

Further, on completion of the controlled tunneling technique for prolonged storage of quantum data, in order to retrieve the stored quantum data, a control pulse may be directed towards the double dot heterostructure. As depicted in FIG. 2(e), directing the control pulse 216 for retrieval of the quantum data may result in the transition of the transiting electron carrying quantum data from the storage state to the excited state, after which the transiting electron carrying quantum data may spontaneously move towards the ground state. Once the transiting electron carrying quantum data transits to the ground state, it may be emitted from the double dot heterostructure. The quantum data may be emitted from double dot heterostructure as the signal pulse 218. Therefore, the ping-pong phenomenon as discussed, provides enhanced storage time of quantum data.

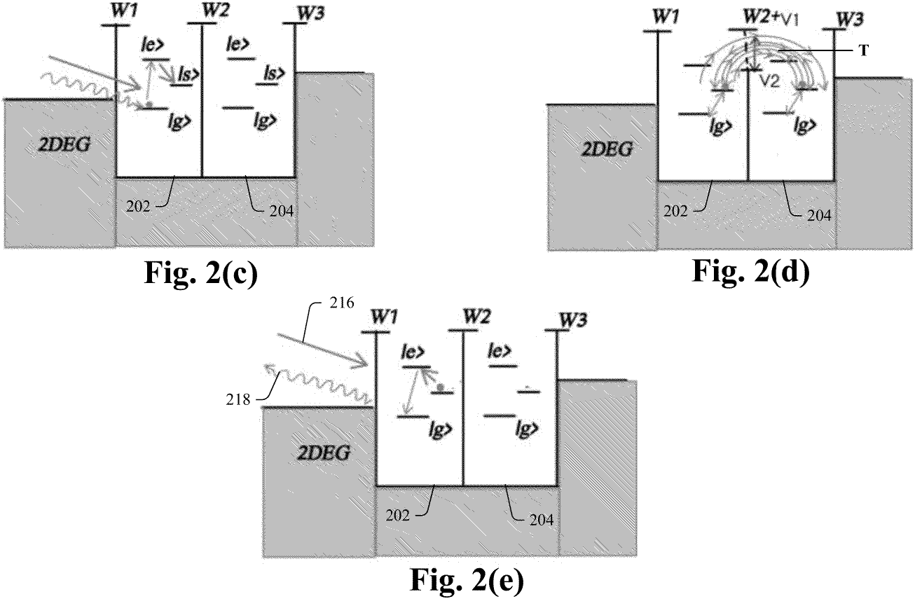

FIG. 3 illustrates a method for localized error correction, in accordance with an example implementation of the present subject matter. At block 302, the method 300 includes obtaining quantum data from an input quantum channel to be stored in a memory unit. As discussed above, the quantum data obtained from the input quantum channel may be multiplexed and directed towards a memory unit of the quantum memory. In one example, the quantum data directed towards the memory unit may be stored intermediately in a first medium, after which it may be stored in a multiple dot heterostructure. In another example, the quantum data directed towards the memory unit may be directly stored in the multiple dot heterostructure.

At block 304, the method 300 includes storing quantum data in a multiple dot heterostructure by subjecting the quantum data to electromagnetically induced transparency. In one example, the multiple dot heterostructure structure may be a part of the memory unit. The multiple dot heterostructure may include a plurality of quantum dots. Each quantum dot may be formed and controlled externally through a nano-gate assembly. In one example, the multiple dot heterostructure may include a pair of quantum dots, namely a first quantum dot and a second quantum dot, collectively and alternatively referred to as a double dot heterostructure.

In one example, each double dot heterostructure may be positioned at a distance from a point where the quantum data is first incident on the first medium, alternatively referred to as a first end of the first medium. For example, a first double dot heterostructure may be positioned at a distance X₁ from a first end of the first medium. Similarly, a second double dot heterostructure may be positioned at a distance X₂ from the first end of the first medium, and the like. Each quantum dot of the double dot heterostructure may include a potential well formed between potential walls. The voltage of the potential wall may be maintained and controlled by a nano-gate assembly associated with the quantum dot. In one example, the nano-gate assembly may in turn be controlled by a control panel. The control panel may be configured to maintain the voltage of the potential walls at a desired range, as discussed above, with reference to FIG. 1.

The quantum data that enters the first quantum dot may interact with a single electron present in the first potential well of the first quantum dot. In one example, the first quantum dot of the multiple dot heterostructure may borrow the single electron from a material surrounding the multiple dot heterostructure. In one example, the material surrounding the multiple dot heterostructure may be a 2D-Electron Gas (2DEG). The interaction between the electron and the quantum data, at resonance, may result in an absorption of the quantum data, as explained above. The quantum data may be absorbed in the first quantum dot of the multiple dot heterostructure by being subjected to the EIT technique, where quantum data may exist in multiple states of energy.

The multiple states of energy may be arranged in a vee type configuration, a delta type configuration, or a lambda type configuration. Although the following description has been explained with respect to the lambda configuration formed by three states of energy, similar principles may be applicable to higher number energy states and different configuration arrangements of the energy states. In one example, three states of energy may be formed in the first quantum dot, namely, a ground state, an excited state, and a storage state, arranged in a lambda configuration. The three states of the potential well may be arranged, such that the ground state is at the lowest level of the potential well, the excited state is at the highest level of the potential well and the storage state is in between the ground state and the excited state.

As discussed with reference to FIG. 1, on achieving electromagnetically induced transparency, the absorption process ceases. Once the absorption process ceases, the control pulse and the signal pulse may be turned off for a second pre-determined amount of time. When the control pulse and the signal pulse are turned off, the quantum data may be stored at the storage state. In one example, the quantum data may rest in a state of coherence at the storage state for a first preset amount of time ‘t’, after which the quantum data may start to decohere or decay spontaneously.

In one example, when quantum data is stored in the storage state, spin wave fluctuations may occur. The spin wave fluctuations may result in the decoherence, or decay of the quantum data stored, thereby introducing an error in the quantum data stored. The error introduced in the quantum data stored in one multiple dot heterostructure, for example, the first multiple dot heterostructure at distance X₁ may be different from the error introduced in the quantum data stored in another multiple dot heterostructure, for example, in the second heterostructure at distance X₂.

At block 304, the method 300 includes performing an error correction on the quantum data stored in the multiple dot heterostructure based on a location of the multiple dot heterostructure. In one example, correcting an error in the quantum data stored in the multiple dot heterostructure, by manipulating spin wave fluctuations of the stored quantum data. In one example, a spin blockade regime may be utilized for localized error correction, where an external signal may be directed towards the quantum data stored in the multiple dot heterostructure. The external signal may be directed towards the quantum data stored for manipulating the spin wave fluctuations. In one example, the external signal may be a microwave pulse in which a sequence for spin wave manipulation may be provided. The sequence may be dependent on the type of error to be corrected. Errors such as phase flip error, bit flip error, phase-bit flip error, and the like, may be corrected by using appropriate sequences, as would be understood to a person skilled in the art.

In one example, the localized error correction may be performed based on the distance of the multiple dot heterostructure from the first end of the first medium. In another example, the localized error correction may be performed independent of the distance of the multiple dot heterostructure from the first end of the first medium. In the example where the localized error correction may be performed based on the distance of the multiple dot heterostructure, the average error at each multiple dot heterostructure may be computed based on an error function as depicted below in equation (2):

$$\text{E} \left(\text{x,} \text{Ω}\right) \qquad \text{(2)}$$

Where, E represents the average error function, x corresponds to a distance from the incident end of quantum data on the first medium, and Ω corresponds to a parameter of the first medium. In one example, the average error function may be generated from a machine learning model.

In one example, manipulation of the spin wave fluctuation may be performed based on the function as depicted below in equation (3):

$$\text{M} \left\{\text{E} \left(\text{x,} \text{Ω}\right)\right\} \qquad \text{(3)}$$

Where, M represents the spin manipulation to be performed at the multiple dot heterostructure and E (x, Ω) corresponds to the error function. In one example, the spin wave manipulations may be implemented by the control panel connected to the nano-gate assembly.

The localized error correction may be elucidated with the following example. The description is not to be construed as limited to the example implementations described. In one example, the first medium of the memory unit with four multiple dot heterostructures is considered, where each multiple dot heterostructure is a double dot heterostructure. The first double dot heterostructure is positioned at a distance X1 from the first end of the first medium, the second double dot heterostructure is at a distance X2 from the first end of the first medium, the third double dot heterostructure is positioned at a distance X3 from the first end of the first medium, and the fourth double dot heterostructure structure is at a distance X4 from the first end of the first medium. Each of the first, second, third, and fourth double dot heterostructures may be controlled by a first nano-gate assembly, a second nano-gate assembly, a third nano-gate assembly, and a fourth nano-gate assembly, respectively. The spin wave manipulation at the first double dot heterostructure may be implemented by the first nano-gate assembly, where the spin manipulation corresponds to M {E (X₁, Ω)} and X1 is the distance of the first double dot heterostructure from the first end of the first medium. Similarly, the spin wave manipulation at the second double dot heterostructure may be implemented by the second nano-gate assembly, where the spin manipulation corresponds to M {E (X2, Ω)} and X2 is the distance of the second double dot heterostructure from the first end of the first medium, the spin wave manipulation at the third double dot heterostructure may be implemented by the third nano-gate assembly, where the spin manipulation corresponds to M {E (X3, Ω)} and X3 is the distance of the third double dot heterostructure from the first end of the first medium, and the spin wave manipulation at the fourth double dot heterostructure may be implemented by the fourth nano-gate assembly, where the spin manipulation corresponds to M {E (X₄, Ω)} and X₄ is the distance of the fourth double dot heterostructure from the first end of the first medium.

In one example, the localized error correction at multiple dot heterostructures may be performed simultaneously with the ping-pong phenomenon as discussed with reference to FIGS. 2(a)-2(e). In another example, the localized error correction may be performed separately, after the ping-pong phenomena. In yet another example, localized error correction can take place multiple times, i.e., quantum data emitted from one multiple dot heterostructure after being subjected to error correction may be absorbed by another multiple dot heterostructure, subsequently. Therefore, the technique of localized error correction of the present subject matter improves the fidelity of the stored data, thereby preventing the deterioration in the quality of the data stored.

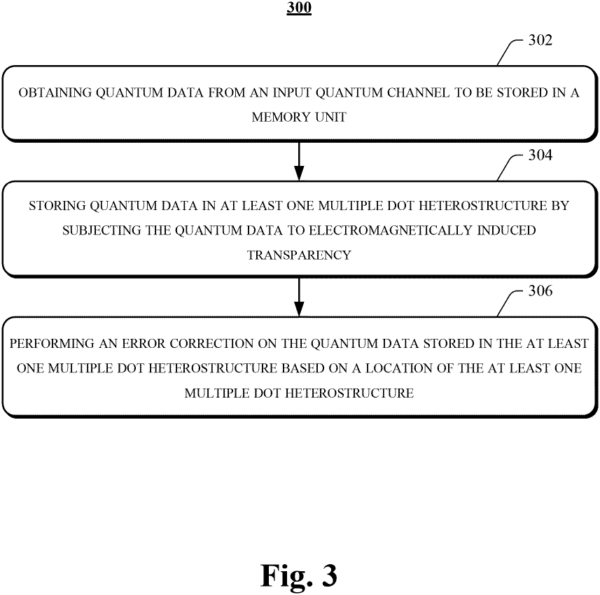

FIG. 4 illustrates a quantum storage environment 400 with an ultra-long storage assisted quantum memory 402, in accordance with an example implementation of the present subject matter. The ultra long storage assisted quantum memory 402, alternatively referred to as quantum memory 402 includes a multiplexer 404, a demultiplexer 406, and a memory unit 410. In one example, quantum data may be obtained as an input from an input quantum channel 412. For example, the input quantum channel 412 may be an optical fiber specialized for single-photon quantum data. The multiplexer 404 of the quantum memory 402 may be configured to receive quantum data in the form of photonic qubits. In one example, the input quantum channel 412 may be coupled to the multiplexer 404 through an interface 414 of the quantum memory 402. In one example, the interface 414 may include a fiber optic system to couple various components of the quantum memory 402. The multiplexer 404 of the quantum memory 402 may be configured to multiplex the quantum data received as input and direct the multiplexed quantum data to the memory unit 410.

In one example, the memory unit 410 may be divided into multiple portions based on the functions the memory unit 410 may be configured to perform. For example, but not limited to, in a scenario where the memory unit 410 may be divided into multiple portions, a first portion of the memory unit may be for storage of quantum data with controlled tunnelling for prolonged storage, and a second portion of the memory unit may be for localized error correction to improve fidelity of the quantum data stored. In another example, the memory unit 410 may be a single unit in which the storage of quantum data with controlled tunnelling for prolonged storage and the localized error correction may take place simultaneously.

In one example, the memory unit 410 may include a first medium 416. In one example, the first medium 416 may be a metallofullerene encapsulated in a carbon nanotube for storing quantum data. Quantum data directed to the first medium 416, may be stored in the first medium for a first pre-determined amount of time. In one example, the first pre-determined amount of time may be dependent on the inherent characteristics of the metallofullerene encapsulated carbon nanotube. Further, at least one multiple dot heterostructure, collectively referred to as multiple dot heterostructure 418 may be formed in the first medium 416. In one example, the multiple dot heterostructure 418 may be formed in the first medium 416 at a predefined distance from one another. In one example, the multiple dot heterostructures 418 are to store quantum data for a second pre-determined amount of time. Each multiple dot heterostructure 418 may be formed at a fixed distance from a first end of the first medium 416. In one example, the first end of the first medium 416 may be where the quantum data is first incident on the first medium. For example, a first multiple dot heterostructure may be formed at a distance X1 from the first end of the carbon nanotube, a second multiple dot heterostructure may be formed at a distance X2 from the first end of the carbon nanotube, and the like. The multiple dot heterostructures 418 formed in the first medium 416 may be controlled by a nano-gate assembly. In one example, each multiple dot heterostructure may be formed and controlled by a corresponding nano-gate assembly. The nano-gate assembly corresponding to each multiple dot heterostructure 418 may in turn be controlled by a control panel 420.

In one example, the control panel 420 may further include a first control panel (not shown in the figure) for the ping-pong phenomenon and a second control panel (not shown in the figure) for localized error correction. The first control panel may control the voltage and current of the nano-gate assembly, in order to control the potential of the potential wells formed in the multiple dot heterostructures 418, to facilitate the controlled tunnelling of the quantum data. Similarly, the second control panel be to manipulate spin wave fluctuations to correct the error in the quantum data stored in the multiple dot heterostructure 418. In another example, the first control panel and the second unit may control the voltage and current of the nano-gate assembly corresponding to each multiple dot heterostructure, as well as manipulate spin wave fluctuations for localized error correction of quantum data stored in the multiple dot heterostructure. In one example, the second control panel may be provided with a machine learning module to perform error correction in the multiple dot heterostructure. In one example, the second control panel may execute the machine learning module, in order to generate an error function based on the distance of the multiple dot heterostructure from the first end of the first medium. In another example, the error function generated by the machine learning module may be independent of the distance of the multiple dot heterostructure from the first end of the first medium.

Further, quantum data emitted from the multiple dot heterostructure may be emitted from the memory unit 410 or may be re-absorbed by the first medium 416 of the memory unit 410. The quantum data re-absorbed in the first medium 416 may be re-stored for the first pre-determined amount of time. The quantum data emitted from the memory unit 410 may be directed towards the demultiplexer 406 to de-multiplex the quantum data. In one example, the demultiplexer 406 may be coupled to the memory unit 410 through the interface 414. Similarly, quantum data from the demultiplexer 406 of the quantum memory 402 may be directed towards an output quantum channel 422, through the interface 414. In one example, the output quantum channel 422 may be an optical fiber specialized for single-photon quantum data.

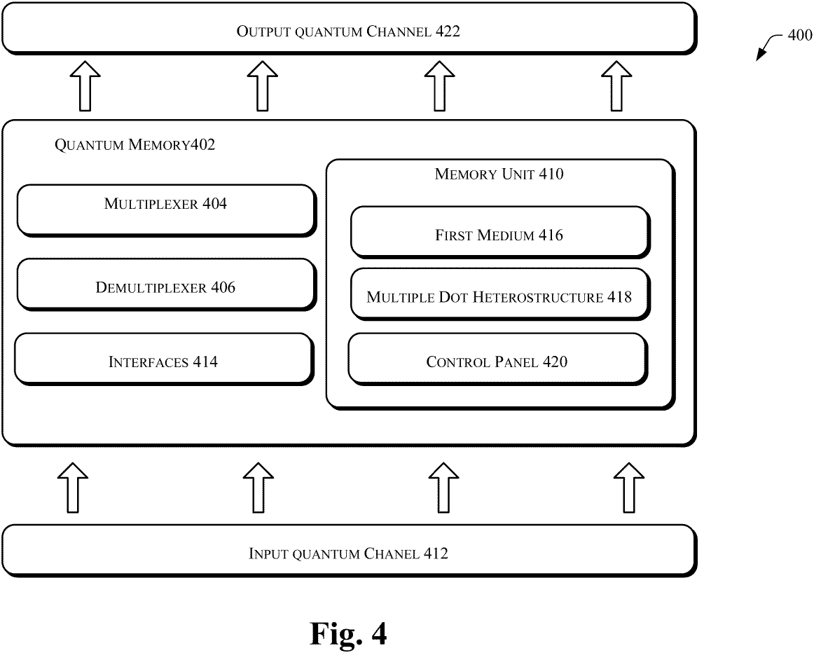

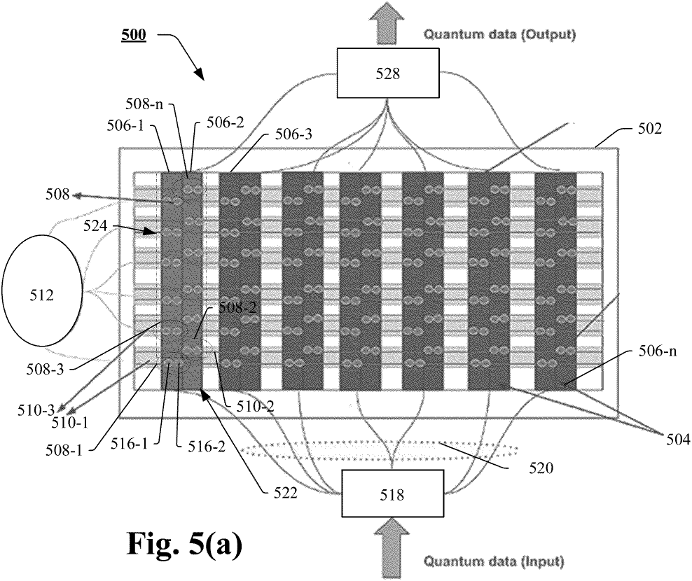

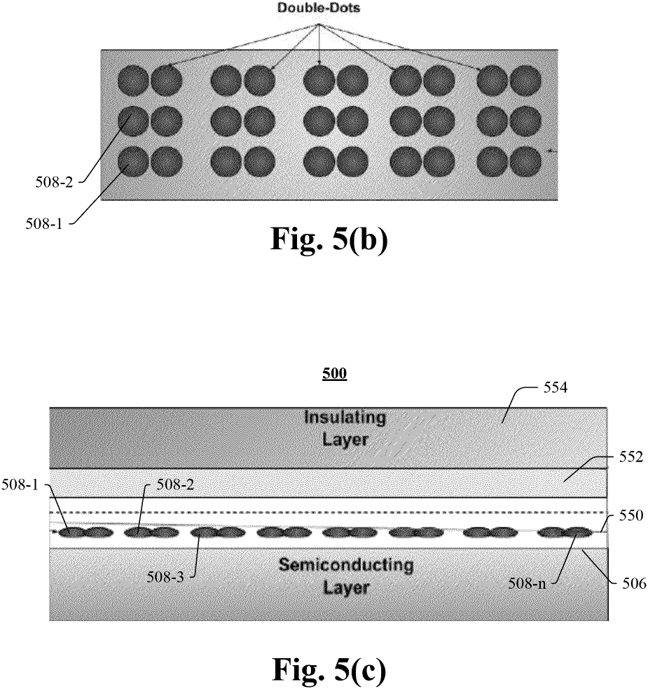

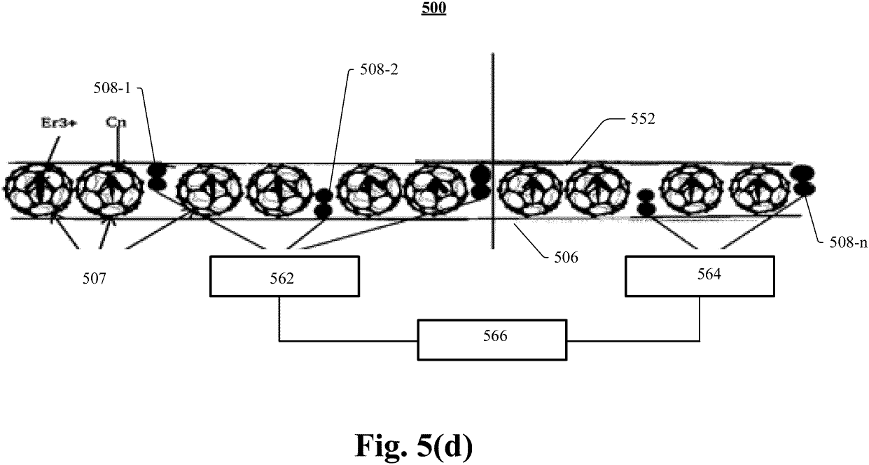

FIG. 5(a) illustrates a schematic representation of the quantum memory 500, in accordance with an example implementation of the present subject matter. The quantum memory 500 includes a memory unit 502 provided with a first medium 504. In one example, the first medium 504 may be a single metallofullerene encapsulated carbon nanotube, alternatively referred to as carbon nanotube. In another example, the first medium 504 may be provided with multiple metallofullerene encapsulated carbon nanotubes 506-1, 506-2, 506-3, ...506-n, collectively referred to as, carbon nanotubes 506. The carbon nanotubes 506 may be positioned parallel to one another. For example, carbon nanotubes, such as single walled carbon nanotubes (SWCNT), or double walled carbon nanotubes (DWCNT) may be used. In one example, the metallofullerene may be a rare earth element caged into fullerene bucky ball. In one example, the metallofullerene may be an Erbium ion (Er³⁺) caged fullerene bucky ball. The metallofullerene bucky balls may be embedded in the carbon nanotubes 506.

In one example, each carbon nanotube 506, may be provided with a plurality of multiple dot heterostructures 508-1, 508-2, 508-3, ...508-n, collectively referred to as multiple dot heterostructure 508. Each multiple dot heterostructure 508-1, 508-2, 508-3, ...508-n, may be controlled by a corresponding nano-gate assembly 510-1, 510-2, 510-3, ... 510-n, collectively referred to as nano-gate assembly 510. Further, each nano-gate assembly 510-1, 510-2, 510-3, ...510-n may be controlled by a control panel 512. In one example, the multiple dot heterostructures may be arranged as depicted in FIG. 5(b), where FIG. 5(b) illustrates a top view of the multiple dot heterostructure, in accordance with an example of the present subject matter. Further, each multiple dot heterostructure 508 may include a plurality of quantum dots. In one example, the multiple dot heterostructure may be a double dot heterostructure 508 as depicted in the FIG. 5(a).

For the sake of simplicity, the following description has been discussed with reference to a first double dot heterostructure 508-1 of the first carbon nanotube 506-1. However, similar principles are applicable to any multiple dot heterostructure 508 of any carbon nanotube 506. The first double dot heterostructure 508-1 includes a first quantum dot 516-1 and a second quantum dot 516-2. The first quantum dot 516-1 and the second quantum dot 516-2 may be controlled by the nano-gate assembly 510-1.

In one example, a signal pulse carrying the quantum data may be obtained as input from an input quantum channel 518.The input quantum channel 518 may be coupled to a multiplexer 520 of the quantum memory 500. The multiplexer 520 and the input quantum channel 518 may be coupled to one another through a fiber optic coupler (not shown in the figure). The multiplexer 520 may be configured to multiplex the quantum data obtained as input and direct the multiplexed quantum data towards a first end 522 of the first carbon nanotube 506-1. In one example, the quantum data may be stored intermediately in the first metallofullerene encapsulated carbon nanotube 506-1. The quantum data may be stored in the first carbon nanotube 506-1 for a first pre-determined amount of time, after which the quantum data may be emitted. In one example, the first pre-determined amount of time may be dependent on a characteristic of the metallofullerene encapsulated carbon nanotube 506-1.

In one example, the quantum data emitted from the first carbon nanotube 506-1 may be absorbed by the first double dot heterostructure 508-1, by subjecting the quantum data to electromagnetically induced transparency. The quantum data may enter the first quantum dot 516-1 and interact with a single electron present in the first potential well (not shown in the figure) of the first quantum dot 516-1. The single electron may be obtained from a 2D Electron Gas (2DEG) film provided on a top layer of the carbon nanotube 506-1, as explained with reference to FIG. 5(c). The signal pulse carrying the quantum data and a control pulse may be provided to facilitate the EIT phenomenon in order to store the quantum data in the double dot heterostructure 508-1.

In one example, the control panel 512 may be configured to control the nano-gate assembly 510-1 corresponding to the first double dot heterostructure 508-1, to control the potential wells of each quantum dot. The potential of the potential walls may be controlled to facilitate the ping-pong phenomenon for prolonged storage of quantum data. In another example, the control panel 512 is to control the manipulation of spin wave fluctuations that occur in quantum data absorbed in the first quantum dot 516-1 and the second quantum dot 516-2 to facilitate localized error correction, for improved fidelity. In one example, the ping-pong phenomenon and the localized error corrections may occur simultaneously. In one example, once the data is emitted from the double dot heterostructure 508 after a second pre-determined amount of time, the quantum data may be re-absorbed by an upper portion 524 of the carbon nanotube 506-1. Therefore, the quantum memory 500 facilitates storage of quantum data multiple times for prolonged storage, i.e., the absorption and re-absorption of the quantum data into the first medium or the multiple double dot heterostructure of the memory unit. Additionally, the quantum memory 500 facilitates improving the fidelity of the quantum data stored.

Further, quantum data emitted from the memory unit 502 may be directed towards a demultiplexer (not shown in the figure) of the quantum memory 500. In one example, the demultiplexer and the carbon nanotube 506-1 of the memory unit 502 may be coupled to one another through a fiber optic coupler (not shown in the figure). Demultiplexed quantum data from the demultiplexer may be directed to an output quantum channel 528, from which quantum data may be transmitted or shared.

FIG. 5(c) illustrates a partial lateral view of the quantum memory 500, in accordance with an example of the present subject matter. As can be observed from the figure, multiple dot heterostructure 508-1, 508-2, 508-3, ...508-n, may be formed in the first medium. Each multiple dot heterostructure may be formed and controlled by a nano-gate assembly. A line 550 collectively represents the voltage and current control provided by each nano-gate assembly. In one example, the voltage and current control may be provided by a control panel (not shown in the figure).

In one example, to facilitate the EIT phenomenon for storing data in the multiple dot heterostructure 508, the multiple dot heterostructure 508 may be provided with a single electron. The single electron may be provided from the 2D Electron Gas (2DEG) film 552 provided on the top layer of the metallofullerene encapsulated carbon nanotube 506. The single electron provided, may be contained in potential wells (not shown in the figure) of the multiple dot heterostructure 508. In a scenario, where the single electron tunnels out of the multiple dot heterostructure 508 before quantum data is stored, the control panel may detect such an instance and accordingly initiate the process of borrowing a single electron from the 2DEG film 552 to facilitate quantum data storage. Additionally, the quantum memory 500 is provided with an insulation layer 554. In one example, the insulation layer 554 may be provided to trap electrons in the 2DEG film.

FIG. 5(d) illustrates another schematic representation of the quantum memory 500, in accordance with another example implementation of the present subject matter. In one example, the multiple dot heterostructures 508-1, 508-2, ...508-n, provided in the metallofullerene bucky ball 507 encapsulated carbon nanotube 506 as discussed above may be divided into a plurality of groups based on a function they may be configured to perform. For example, as depicted in the figure, a first group of the multiple dot heterostructures 508 may be controlled by a first control panel 562 to store data quantum data based on the ping-pong phenomenon. Similarly, the second group of multiple dot heterostructures 508 may be controlled by a second control panel 564 for localized error correction.

The first control panel 562 may control the voltage and current of the nano-gate assembly, in order to control the potential of the potential wells formed in the first group of multiple dot heterostructures 508, to facilitate the ping-pong phenomenon, as discussed above. Similarly, the second control panel 564 may be to manipulate spin wave fluctuations to correct the error in the quantum data stored in the second group of multiple dot heterostructure 508, as discussed above. In one example, the first control panel 562 may provide information regarding the quantum data stored in the first group of multiple dot heterostructures 508 to the second control panel 564, through a machine learning model 566. In one example, the machine learning model 566 may be executed by the second control panel 564 in order to generate an average error function, based on which spin wave fluctuations may be manipulated.

Therefore, as quantum data may be stored in the first group of multiple dot heterostructures 508 for prolonged storage time, and quantum data emitted from the first group of multiple dot heterostructures may be re-absorbed by the second group of multiple dot heterostructures for localized error correction, the quantum memory 500 facilitates increasing fidelity of the quantum data stored, in addition to providing prolonged storage of quantum data.

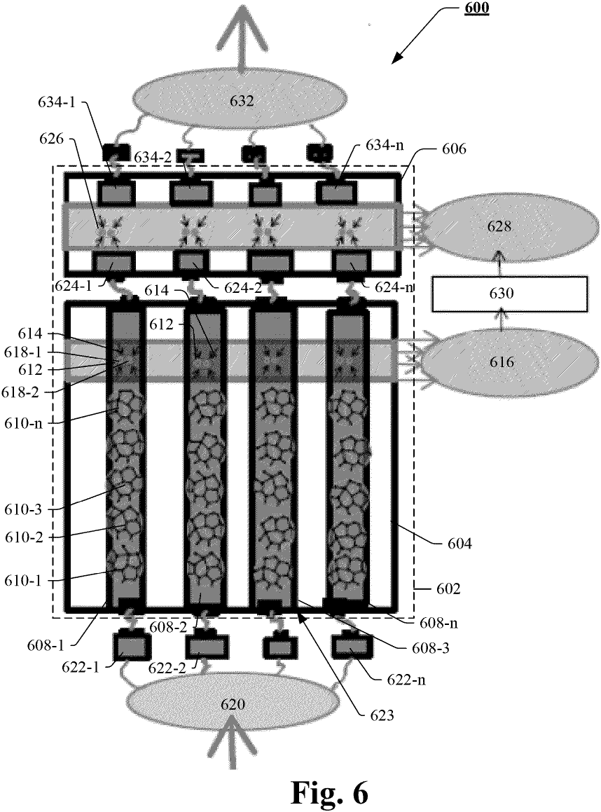

FIG. 6 illustrates a schematic representation of the quantum memory 600, in accordance with another example implementation of the present subject matter. The quantum memory 600 includes a memory unit 602. In one example, but not limited to, the memory unit 602 may be divided into multiple portions, where each portion of the memory unit 602 may include any one of a first medium or a multiple dot heterostructure, or a combination thereof. As depicted in the figure, the memory unit 602 may be divided into a first portion 604 of the memory unit and a second portion 606 of the memory unit.

In one example the first portion 604 of the memory unit may be provided with a first medium 608. In one example, the first medium 608 may be a single metallofullerene encapsulated carbon nanotube, alternatively referred to as carbon nanotube 608. In another example, the first medium 608 may be provided with multiple metallofullerene encapsulated carbon nanotubes 608-1, 608-2, 608-3, ...608-n, collectively referred to as, carbon nanotubes 608. In one example, the carbon nanotubes 608 may be positioned parallel to one another. For example, carbon nanotubes, such as single walled carbon nanotubes (SWCNT), or double walled carbon nanotubes (DWCNT) may be used. In one example, each carbon nanotube 608 may be provided with metallofullerene bucky balls 610-1, 610-2, ...610-n, collectively referred to as metallofullerene bucky ball 610 of the carbon nanotubes 608. In one example, the metallofullerene may be a rare earth element doped fullerene bucky ball. In one example, the metallofullerene may be an Erbium ion (Er³⁺) caged fullerene bucky ball.

Further, each carbon nanotube 608, may be provided with a multiple dot heterostructure 612. In another example, each carbon nanotube 608 may be provided with a plurality of multiple dot heterostructures (not shown in the figure). In one example, the multiple dot heterostructure 612 may be formed and controlled by a nano-gate assembly 614. Each multiple dot heterostructure 612 may be controlled by a corresponding nano-gate assembly. Each nano-gate assembly 614 may in turn be controlled by a first control panel 616.

In one example, each multiple dot heterostructure 612 may include a plurality of quantum dots. In one example, the multiple dot heterostructure 612 may be a double dot heterostructure 612. For the sake of simplicity, the following description has been discussed with reference to one double dot heterostructure 612 of the first carbon nanotube 608-1 provided in the first portion 604 of the memory unit. However, similar principles are applicable to any multiple dot heterostructure of any carbon nanotube provided in any portion of the memory unit.

As shown in the figure, the double dot heterostructure 612 includes a first quantum dot 618-1 and a second quantum dot 618-2. The first quantum dot 618-1 and the second quantum dot 618-2 may be controlled by the nano gate assembly 614. The first control panel 616 may control the voltage and current of the potential walls formed in the first quantum dot 618-1 and the second quantum dot 618-2.

In one example, quantum data may be obtained as input from an input quantum channel (not shown in the figure). The input quantum channel may be coupled to a multiplexer 620 of the quantum memory 600. The multiplexer 620 and the input quantum channel may be coupled to one another through a first set of fiber optic couplers 622-1, 622-2, ...622-n. The multiplexer 620 may multiplex the quantum data obtained as input from the input quantum channel and direct the multiplexed quantum data towards a first end 623 of the carbon nanotubes 608-1, 608-2, 608-3, ...608-n, respectively.

In one example, the quantum data may be stored in the metallofullerene encapsulated carbon nanotubes 608 intermediately, for a first pre-determined amount of time. In one example, the first pre-determined amount of time may be dependent on a characteristic of the metallofullerene encapsulated carbon nanotube 608. In another example, the first pre-determined amount of time may be controlled, by subjecting the quantum data to an atomic frequency comb technique, by methods known in the art. In one example, an atomic frequency comb may be created in the metallofullerene encapsulated carbon nanotubes 608. A control pulse for storing the quantum data based on the AFC technique may be provided to facilitate storing of quantum data in the first medium of the memory unit. Further, the quantum data may be emitted from the metallofullerene bucky ball 610 after the first pre-determined amount of time.

In one example, the quantum data emitted from the carbon nanotube 608 may be absorbed by the double dot heterostructure 612, by subjecting the quantum data to electromagnetically induced transparency. The quantum data may enter the first quantum dot 618-1 and interact with a single electron present in the first potential well (not shown in the figure) of the first quantum dot 618-1. The single electron may be obtained from a 2D Electron Gas film (not shown in the figure) provided on a top layer of the carbon nanotube 608. A signal pulse carrying the quantum data and a control pulse for the EIT technique may be provided to facilitate the EIT phenomenon in order to store the quantum data in the double dot heterostructure 612.

In one example, the first control panel 616 may be configured to control the nano-gate assembly 614 to control the potential at the potential walls of the potential wells formed in the double dot heterostructure 612 to facilitate the ping-pong phenomenon for prolonged storage of quantum data. In one example, on completion of the ping-pong phenomenon, quantum data may be emitted from the double dot heterostructure 612 provided in the first portion 604 of the memory unit and may be directed towards the second portion 606 of the memory unit. In one example, the first portion 604 of the memory unit and the second portion 606 of the memory unit may be coupled to one another through a second set of fiber optic couplers 624-1, 624-2, ...624-n.

The second portion 606 of the memory unit includes at least one multiple dot heterostructures 626. In one example, quantum data directed towards the second portion 606 of the memory unit may be absorbed by a second double dot structure 626, on subjecting the data to the EIT technique. For the sake of simplicity, the following description has been discussed with respect to a single double dot heterostructure 626 of the second portion 606 of the memory unit. However, similar principles may be applicable to the plurality of multiple dot heterostructures provided in any portion of the memory unit.

In one example, when data is stored in the second double dot heterostructure 626, localized error corrections may be performed by manipulating the spin wave fluctuations which occur during the storage of quantum data. In one example, a second control panel 628 may be provided to facilitate localized error correction. The localized error correction may be performed based on the quantum data absorbed by the double dot heterostructure. In one example, a machine learning module 630 may be executed by the second control panel 628 in order to generate an average error function, based on which spin wave fluctuations may be manipulated. In one example, the first control panel 616 and the second control panel 628 may be a part of a master control panel, in order to control multiple nano-gate assemblies for prolonged storage of quantum data and simultaneously perform localized error correction in the stored data.

In one example, quantum data may be emitted from the second double dot heterostructure 626 of the second portion 606 of the memory unit 602 after a second pre-determined amount of time. The quantum data emitted from the second portion 606 of the memory unit, may be directed towards the demultiplexer 632 of the quantum memory 600. In another example, the quantum data emitted from the second double dot heterostructure may be reabsorbed by carbon nanotubes that may be provided in the second portion of the memory unit (not shown in the figure). In one example, the demultiplexer 632 and the second portion 606 of the memory unit may be coupled to one another through a third set of fiber optic couplers 634-1, 634-2, ...634-n. The demultiplexed quantum data from the demultiplexer 632 may be further directed towards an output quantum channel (not shown in the figure), from where quantum data may be transmitted or shared. Therefore, the quantum memory 600 facilitates increasing fidelity of the quantum data stored, in addition to prolonged storage of quantum data.

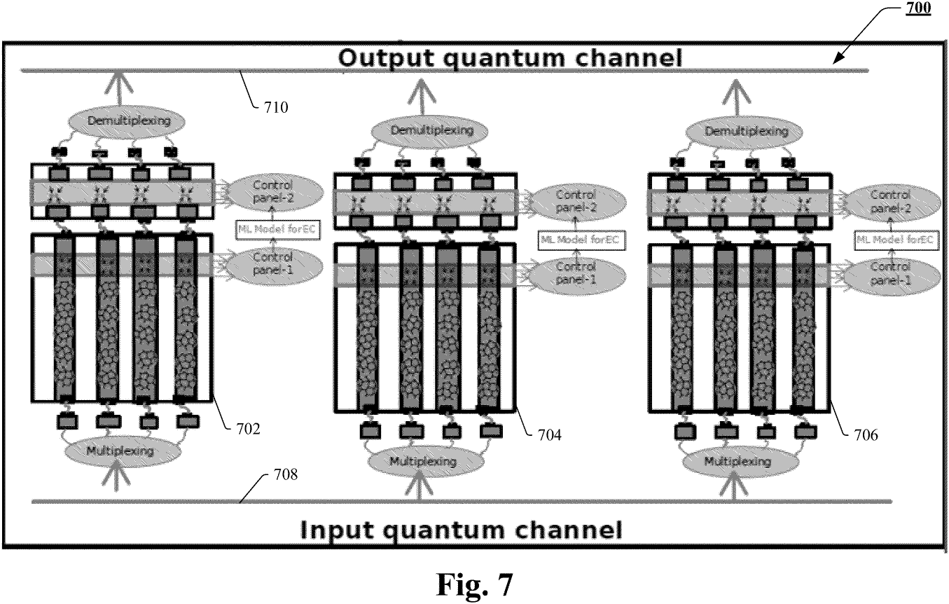

FIG. 7 illustrates a schematic representation with multiple units of quantum memory 700, in accordance with an example implementation of the present subject matter. As depicted in the figure, the quantum memory 700 may include a first memory unit 702, a second memory unit 704, and a third memory unit 706. Each of the memory units 702, 704, 706 may receive quantum data as input from a common input quantum channel 708. In one example, each memory unit may be provided with metallofullerene encapsulated carbon nanotubes, multiple dot heterostructures, multiplexers, demultiplexers, control panels in combinations, but not limited to, as discussed with reference to FIGS. 4-6 for quantum data storage. Further, the quantum data emitted from the first memory unit 702, the second memory unit 704, and the third memory unit 706 may be sent to a common output quantum channel 710, based on a demand for retrieval of quantum data.

Although the present subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for quantum data storage in storage assisted quantum memory, the method comprising:
obtaining quantum data from an input quantum channel to be stored in a memory unit;
storing, intermediately, the quantum data in a first medium of the memory unit for a first pre-determined amount of time;
reabsorbing quantum data emitted from the first medium after the first pre-determined amount of time by at least one multiple dot heterostructure of the memory unit, wherein the at least one multiple dot heterostructure comprises a potential well for storing the quantum data;
storing quantum data in the at least one multiple dot heterostructure for a second predetermined amount of time; and
performing a controlled tunneling of the quantum data stored in the at least one multiple dot heterostructure.

2. The method as claimed in claim 1 comprises multiplexing the quantum data obtained from the input quantum channel for storage in the first medium.

3. The method as claimed in claim 1, wherein the first pre-determined amount of time is based on the first medium.

4. The method as claimed in claim 1, wherein storing the quantum data in the at least one multiple dot heterostructure is performed by subjecting the quantum data to electromagnetically induced transparency.

5. The method as claimed in claim 1, wherein the controlled tunneling of the quantum data comprises sequentially tunnelling the quantum data from one quantum dot of the at least one multiple dot heterostructure to another quantum dot of the at least one multiple dot heterostructure based on a state of coherence of the quantum data.

6. The method as claimed in claim 5, wherein the controlled tunneling of the quantum data comprises
storing the quantum data in a first potential well of the one quantum dot for a first preset amount of time, wherein the first preset amount of time is a time period between the state of coherence and a decoherence state of the quantum data in the first potential well; and
storing the quantum data in a second potential well of another quantum dot for a second preset amount of time, wherein the second preset amount of time is the time period between the state of coherence and the decoherence state of the quantum data in the second potential well.

7. The method as claimed in claim 6 comprising controlling a potential of the first potential well and the second potential well of the at least one multiple dot heterostructure to facilitate controlled tunneling of the stored quantum data.

8. The method as claimed in claim 1, wherein the controlled tunnelling is performed for a predefined number of times.

9. The method as claimed in claim 1 comprises re-absorbing the quantum data emitted from the at least one multiple dot heterostructure into the first medium and restoring the quantum data in the first medium for the first pre-determined amount of time.

10. The method as claimed in claim 1 comprising retrieving the quantum data stored in the first medium of the memory unit by directing a control pulse towards the first medium.

11. The method as claimed in claim 1 comprising retrieving the quantum data stored in the at least one multiple dot heterostructure by directing a control pulse towards the at least one multiple dot heterostructure.

12. A method for error correction in storage assisted quantum memory, the method comprising:
obtaining quantum data from an input quantum channel to be stored in a memory unit;
storing quantum data in at least one multiple dot heterostructure by subjecting the quantum data to electromagnetically induced transparency; and
performing an error correction on the quantum data stored in the at least one multiple dot heterostructure based on a location of the at least one multiple dot heterostructure.

13. The method as claimed in claim 12, wherein error correction is performed by manipulating a spin wave fluctuation of the quantum data.

14. The method as claimed in claim 12 comprises computing an average error based on an average error function, wherein the average error function is based on the location of the at least one multiple dot heterostructure from a point of incidence of the quantum data on a first medium of the memory unit and a parameter of the first medium of the memory unit.

15. An storage assisted quantum memory, comprising:
at least one memory unit, comprising:
a first medium configured to store quantum data, intermediately, for a first pre-determined amount of time; and
at least one multiple dot heterostructure, wherein each of the at least one multiple dot heterostructure comprises a potential well to store the quantum data for a second pre-determined amount of time.

16. The storage assisted quantum memory as claimed in claim 15, wherein each of the at least one multiple dot heterostructure comprises a plurality of quantum dots, wherein each quantum dot comprises the potential well to store the quantum data.

17. The storage assisted quantum memory as claimed in claim 15 comprises a first control panel configured to control a nano-gate assembly corresponding to each of the at least one multiple dot heterostructure, wherein the nano-gate assembly is to control a potential of the potential well formed in each of the plurality of quantum dots to facilitate the controlled tunnelling.

18. The storage assisted quantum memory as claimed in claim 17, wherein the nano-gate assembly is embedded in a material that surrounds the at least one multiple dot heterostructure, wherein the material is a 2D Electron Gas.

19. The storage assisted quantum memory as claimed in claim 15 comprises a second control panel configured to manipulate spin wave fluctuations to correct an error in the quantum data stored in each of the at least one multiple dot heterostructure.

20. The storage assisted quantum memory as claimed in claim 15, wherein the first medium comprises a plurality of metallofullerene encapsulated carbon nanotubes.

21. The storage assisted quantum memory as claimed in claim 20, wherein the plurality of metallofullerene is a rare earth element caged into a fullerene bucky ball.

22. The storage assisted quantum memory as claimed in claim 21, wherein the plurality of metallofullerene is an Erbium ion (Er3+) caged fullerene bucky ball.

23. The storage assisted quantum memory as claimed in claim 15, wherein the at least one multiple dot heterostructure is formed in the first medium at a predefined distance from one another.

24. The storage assisted quantum memory as claimed in claim 15 comprising a plurality of memory units connected to one another in parallel.

25. The storage assisted quantum memory as claimed in claim 15, wherein
a first memory unit of the at least one memory unit comprises the at least one multiple dot heterostructure to store the quantum data; and
a second memory unit of the at least one memory unit comprises the at least one multiple dot heterostructure, wherein the at least one multiple dot heterostructure store quantum data retrieved from the first memory unit for error correction by manipulation of spin wave fluctuations in the stored quantum data.
